(19) United States
(12) Patent Application Publication
(10) Pub. No.: US 2008/0022337 A1
(43) Pub. Date: Jan. 24, 2008

(54) Web camera integral with a clasp

(75) Inventor: Zai-Fu Yang, Sanchung City (TW)

Correspondence Address: COOPER & DUNHAM, LLP, 1185 AVENUE OF THE AMERICAS, NEW YORK, NY, 10036, US

(73) Assignee: Kye Systems Corp.

(21) Appl. No.: 11/519,272

(22) Filed: Sep. 12, 2006

(30) Foreign Application Priority Data
Jul. 24, 2006 (TW) 095126918

(51) Int. Cl. H04N 7/173

(52) U.S. Cl. 725/105

(57) ABSTRACT

A web camera has a bracket, a camera module, and two connecting assemblies. The bracket has a front bracket and a rear bracket mounted pivotally to each other. The camera module is mounted pivotally in the bracket. The connecting assemblies are mounted respectively in two sides of the bracket to mount the front and rear brackets pivotally to each other and to mount the camera module pivotally in the bracket. Each connecting assembly has a torsion spring respectively connecting securely to the front and rear brackets to provide clamping force to the bracket. Therefore, the web camera can be clamped at a desired place.

### BACKGROUND OF THE INVENTION

1. Field of the Invention

The present invention relates to a web camera, and more particularly to a web camera that is formed integrally with a clasp.

2. Description of the Related Art

With the development of the technology, peripherals of computers such as web cameras are introduced into the market gradually. User can transmit the vision of the web cameras through the Internet. To reach desirable quality of the vision and to shoot the vision conveniently, the web camera needs to be attached securely at a desired place.

One of the conventional ways to attach a web camera securely at a desired place is to stick the web camera at the desired place by adhesive. However, when the web camera has to be moved, the adhesive is hard to be removed and is also difficult to be cleaned up.

Another one of the conventional ways to attach a web camera securely at a desired place is used with a clasp. However, the web camera with the clasp occupies a large space. In the trend of thinness and lightness, it can not meet the demand of the consumers.

Therefore, the invention provides a web camera integral with a clasp to mitigate or obviate the aforementioned problems.

### SUMMARY OF THE INVENTION

The main objective of the present invention is to provide a web camera integrally formed with a clasp. The web camera has a bracket, a camera module, and two connecting assemblies. The bracket has a front bracket and a rear bracket mounted pivotally to each other. The camera module is mounted pivotally in the bracket. The connecting assemblies are mounted respectively in two sides of the bracket to mount the front and rear brackets pivotally to each other and to mount the camera module pivotally in the bracket. Each connecting assembly has a torsion spring respectively connecting securely to the front and rear brackets to provide clamping force to the bracket. Therefore, the web camera can be clamped at a desired place.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a web camera integral with a clasp in accordance with the present invention;

FIG. 2 is an exploded perspective view of the web camera integral with a clasp in FIG. 1;

FIG. 3 is a cross-sectional top view of the web camera integral with a clasp in FIG. 1;

FIG. 4 is a side view of the web camera integral with a clasp in FIG. 1;

FIG. 5 is an operational side view of the web camera integral with a clasp in FIG. 1; and

FIG. 6 is an operational side view of the web camera integral with a clasp in FIG. 1.

### DETAILED DESCRIPTION OF THE PREFERRED EMBODIMENT

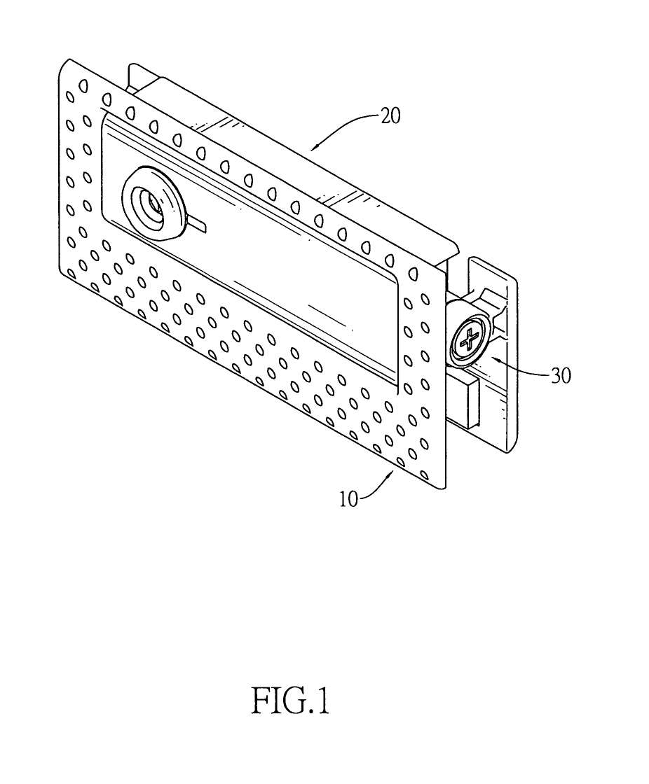

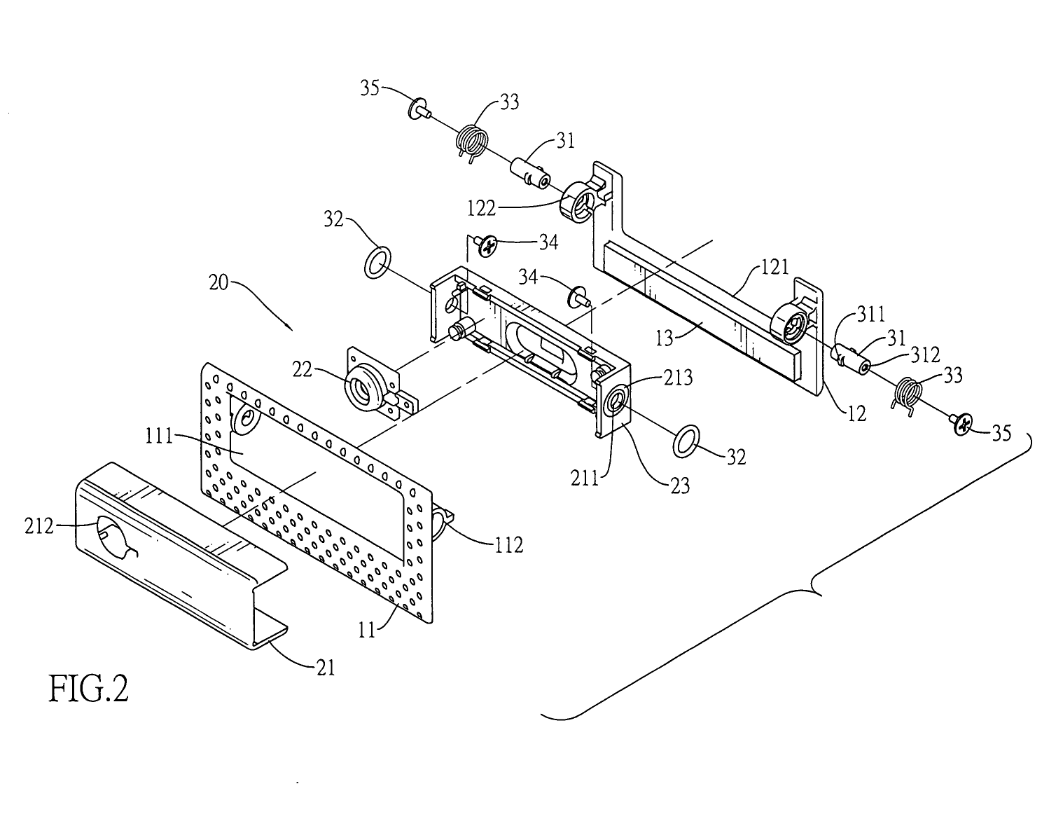

With reference to FIGS. 1 to 2, a web camera integral with a clasp in accordance with the present invention comprises a housing (10), a camera module (20) and two connecting assemblies (30).

The housing (10) comprises a front bracket (11), a rear bracket (12) and two pads (13).

The front bracket (11) has a front surface, a rear surface, a clip end, a free end, two inner collars (112) and an opening (111). The inner collars (112) are formed separately on the rear surface of the front bracket (11). Each inner collar (112) has an inside end and an outside end. The opening (111) is formed through the front bracket (11) and is formed between the collars (112). The rear bracket (12) connects pivotally to the front bracket (11) and has a front surface, a clip end, a free end, two outer collars (122) and a recess (121). The outer collars (122) are formed separately on the front surface of the rear bracket (12). Each outer collar (122) has an inside end and an outside end. The inside ends of the outer collar (122) are respectively adjacent to the outside ends of the inner collar (112). The recess (121) is formed in the free end of the rear bracket (12) and aligns with the opening (111) in the front bracket (11).

The pads (13) are mounted between the front and rear brackets (11, 12). The pads (13) are attached respectively to the rear surface of the front bracket (11) and the front surface of the rear bracket (12).

The camera module (20) is mounted pivotally in the housing (10), corresponds to the opening (111) in the front bracket (11) and the recess (121) in the rear bracket (12) and comprises an outer frame (21), an inner frame (23), a lens (22) and an electrical unit. The outer frame (21) is mounted in the opening (111) in the front bracket (11) and has an aperture (212) formed through the outer frame (21). The inner frame (23) is mounted between the inner collars (112) of the front bracket (11), is attached securely to the outer frame (21) and has two ends, two mounting holes (211) and two annular grooves (213). The ends of the inner frame (23) are mounted between the inner collars (112) of the front bracket (11). The mounting holes (211) are formed respectively through the two ends of the inner frame (23) and align with the collars (112, 122) of the bracket (10). The annular grooves (213) are formed respectively around the mounting holes (211) in the inner frame (23). The lens (22) is mounted securely in the aperture (212) in the outer frame (21).

The connecting assemblies (30) are mounted respectively in two sides of the housing (10), are mounted between the housing (10) and the camera module (20) to mount the camera module (20) pivotally in the housing (10) and are mounted between the front and rear brackets (11, 12) to connect the front and rear brackets (11, 12) pivotally to each other. Each connecting assembly (30) comprises a sleeve (31), a washer (32), a torsion spring (33), an inner fastener (34) and an outer fastener (35).

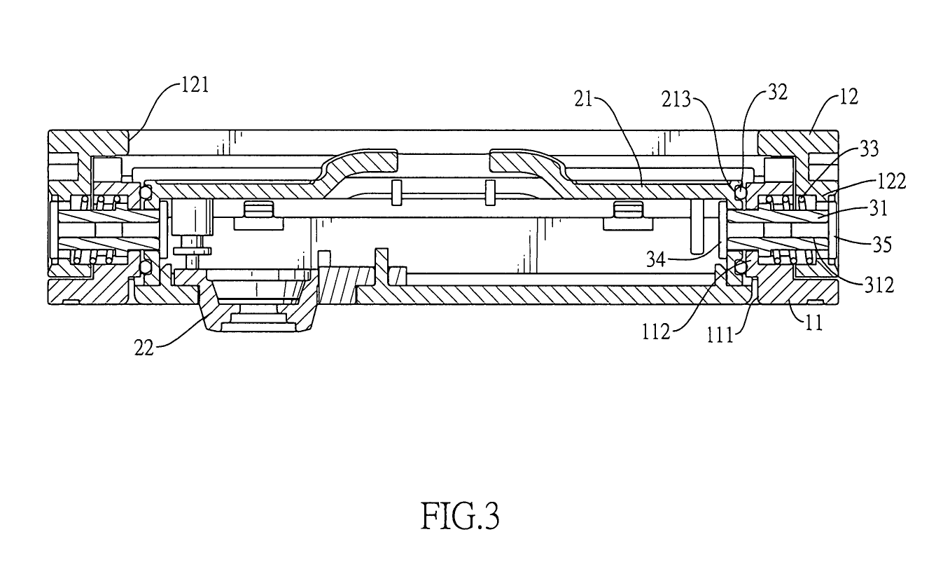

With further reference to FIG. 3, the sleeve (31) extends through the corresponding outer collar (122) of the rear bracket (12), extends through the corresponding inner collar (112) of the front bracket (11) and extends through the corresponding mounting hole (211) in the camera module (20). The sleeve (31) has a sidewall, an axially central hole (312) and two protrusions (311). The protrusions (311) are formed oppositely on the sidewall of the sleeve (31) and abut the corresponding inner collar (112) of the front bracket (11). The central hole (312) in the sleeve (31) may be a threaded hole.

The washer (32) is mounted in the corresponding notch (213) of the inner frame (23) of the camera module (20) and is mounted between the inner frame (23) and the corresponding inner collar (112) of the front bracket (11).

The torsion spring (33) is mounted around the sleeve (31) and connects securely to the inner and outer collars (112, 122) of the front and rear brackets (11, 12). Therefore, the clip ends of the front and rear brackets (11, 12) can clamp an object.

The inner fastener (34) extends through the corresponding mounting hole (211) of the inner frame (21) and is mounted securely in the central hole (312) of the corresponding sleeve (31). The outer fastener (35) extends through the corresponding outer collar (122) of the rear bracket (12) and is mounted securely in the central hole (312) of the corresponding sleeve (31). The inner and outer fasteners (34) hold the bracket (10) and the camera module (20) together. The inner fastener (34) connects the camera module (20) pivotally to the front bracket (11). The outer fastener (35) connects the rear bracket (12) pivotally to the front bracket (11). The inner and outer fasteners (34, 35) may be screws.

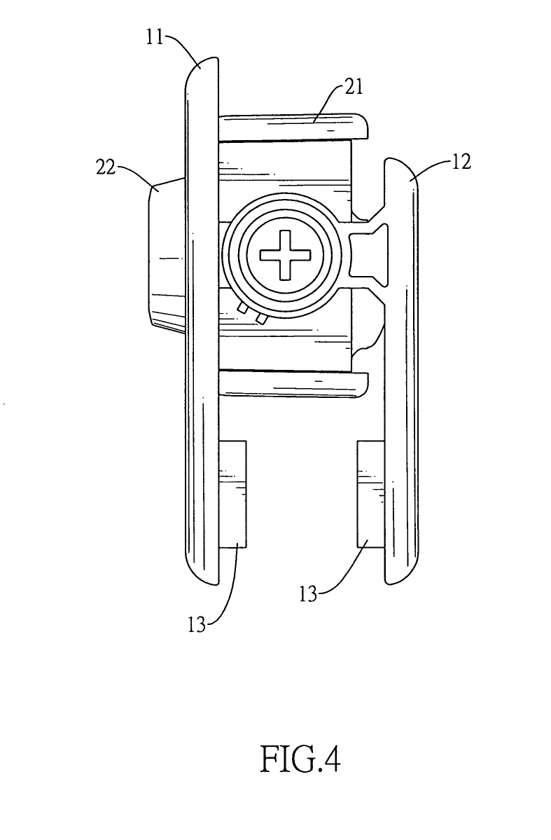

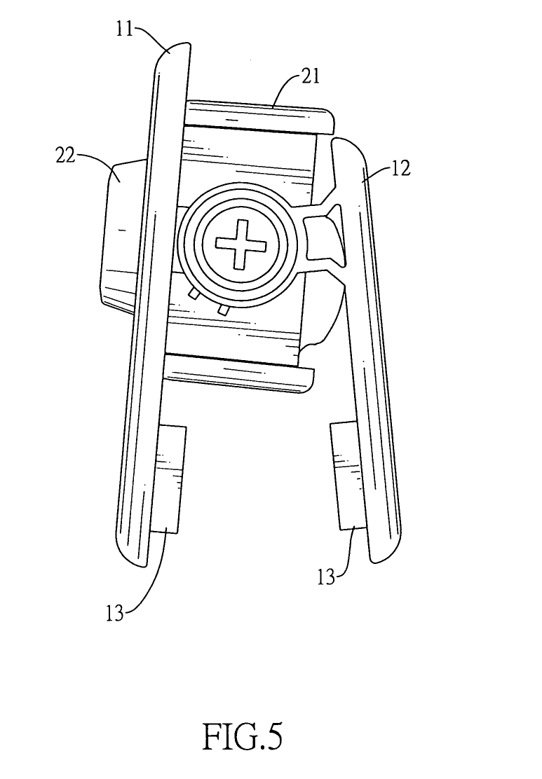

With further reference to FIGS. 4 and 5, the user tends to clamp the web camera as described at a desired place such as a panel. The user forces the top (free-moving end) of the front and rear brackets (11, 12) to move them close so the bottom (a clip end) of the front and rear brackets (11, 12) move away from each other. Then the clip ends of the front and rear brackets (11, 12) are mounted across the panel. When the user releases the free ends of the front and rear brackets (11, 12), the torsion springs (33) forces the clip ends of the front and rear brackets (11, 12) to clamp the panel. Therefore, the web camera is fastened on the panel.

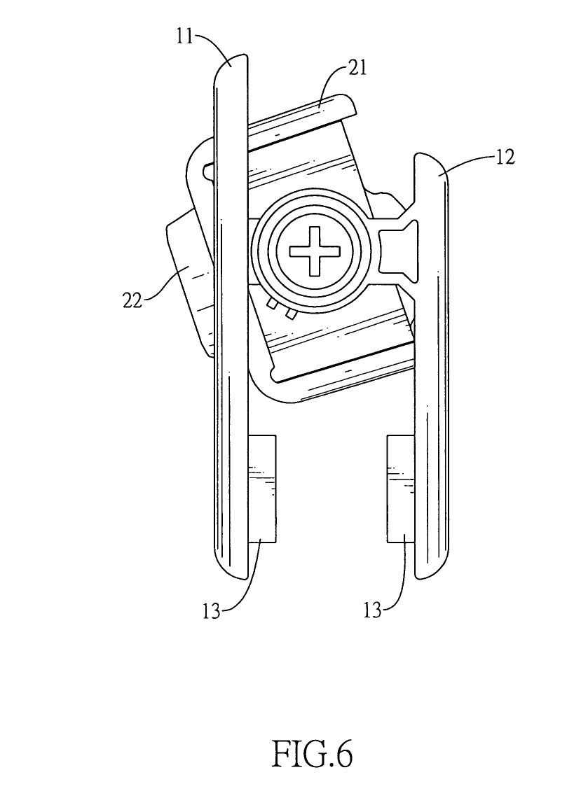

With further reference to FIG. 6, the visual angle of the lens (22) is adjustable. Because the camera module (20) is mounted pivotally in the bracket (10) by the connecting assemblies (30), the user can easily pivot the camera module (20) to adjust the visual angle of the lens (22). The screwing force generated by the inner fastener (34) for coupling to the sleeve (31) is adjustable such that the friction between the washer (32) and inner collar (112) can be varied to facilitate the angle adjustment of the lens (22).

The advantages of the web camera of the present invention are numerous. The housing (10) not only accommodates the camera module (20) but also has a clamping function, such that the camera module (20) is fully received within in the housing (10). Meanwhile a compartment or space is formed between the front bracket (11) and the rear bracket (12), and the camera module 20 can be pivoted in the compartment. Therefore, the one-piece design of the present invention to mount the camera module (20) in the bracket (10) decreases the volume of the web camera. By the torsion springs (33), the web camera has a self-clamping function so is easy to be positioned at any desired place.

Besides, a person in the ordinary skilled in the art is easy to change the camera module (20) of the present invention to any computer-input device that includes but is not limited to a wireless receiver, a microphone, a micro speaker, a micro card reader/writer or a pen drive. Therefore, the present invention is applied for many kind of the computer-input devices.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A web camera integral with a clasp comprising:
a housing comprising a front bracket and a rear bracket;
a camera module mounted pivotally in the housing; and
two connecting assemblies mounted respectively in two sides of the bracket, mounted between the bracket and the camera module to mount the camera module pivotally in the housing and mounted between the front and rear brackets to connect the front and rear brackets pivotally to each other, and each connecting assembly having a torsion spring connecting securely to the front and rear brackets.

2. The web camera integral with a clasp as claimed in claim 1, wherein
each connecting assembly further comprises a sleeve extending through the camera module and the bracket and having an axially central hole; and
the torsion springs are mounted respectively around the sleeves.

3. The web camera integral with a clasp as claimed in claim 2, wherein each connecting assembly further comprises
an inner fastener extending through the camera module and mounted securely in the central hole in the corresponding sleeve; and
an outer fastener extending through the bracket and mounted securely in the central hole in the corresponding sleeve.

4. The web camera integral with a clasp as claimed in claim 3, wherein
the central holes in the sleeves are threaded holes; and
the inner and outer fasteners are screws to be screwed respectively into the threaded holes in the sleeves.

5. The web camera integral with a clasp as claimed in claim 1, wherein the camera module comprises
an inner frame mounted pivotally in the bracket;
an outer frame attached securely to the inner frame; and
a lens mounted securely in the outer frame.

6. The web camera integral with a clasp as claimed in claim 5, wherein
the front bracket has
a rear surface; and
two inner collars formed separately on the rear surface of the front bracket, and each inner collar having an inside end and an outside end;
the rear bracket has
a front surface; and
two outer collars formed separately on the front surface of the rear bracket, and each outer collar having an outside end and an inside end adjacent to the outside end of a corresponding inner collar;
the inner frame is mounted between the inner collars of the front bracket and has
two ends mounted between the inner collars of the front bracket; and
two mounting holes formed respectively through the two ends of the inner frame and aligning with the collars of the bracket; and
each sleeve extends through a corresponding one of the outer collars of the rear bracket, extends through a corresponding inner collar of the front bracket and extends through a corresponding mounting hole in the camera module.

7. The web camera integral with a clasp as claimed in claim 6, wherein each sleeve has
a sidewall; and
two protrusions formed oppositely on the sidewall of the sleeve and abutting the corresponding inner collar of the front bracket.

8. The web camera integral with a clasp as claimed in claim 7, wherein
the front bracket has an opening formed through the front bracket and formed between the collars;
the rear bracket has
a free end; and
a recess formed in the free end of the rear bracket and aligning with the opening in the front bracket; and
the camera module corresponds to the opening in the front bracket and the recess in the rear bracket.

9. A computer input device, comprising a housing, and a body having an electrical unit, wherein the housing has a free end and a clip end, and a compartment is formed between the free end and the clip end; wherein the body is fully received within the compartment, and the body is pivoted within the compartment.

10. A computer input device comprising a clasp, and a body having an electrical unit, wherein the clasp has a compartment and the body is fully received within the compartment, and the body is pivoted within the compartment.
